(19) United States
(12) Patent Application Publication
(10) Pub. No.: US 2007/0294931 A1
(43) Pub. Date: Dec. 27, 2007

(54) FIREARM CLEANER POUCH, PATCH, AND METHOD OF USE

(76) Inventor: Donald C. Kettles, Lansing, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/678,179

(22) Filed: Feb. 23, 2007

Related U.S. Application Data
(60) Provisional application No. 60/776,612, filed on Feb. 24, 2006.

(51) Int. Cl. F41A 29/00; A47L 25/00; B01D 9/02; B65D 33/16

(52) U.S. Cl. 42/95; 15/208; 383/42; 383/63; 510/405

(57) ABSTRACT

A cleaning system includes a foldable pouch made of two polymeric sheets thermally bonded to form two compartments, one with wet melt-blown sheet and another with dry melt-blown sheet, each adapted for cleaning gun barrels and firearm components. The compartments are closed with zip-lock closure members offering easy access and resealability. The pouch is foldable and takes up minimal space, such that it is lightweight and able to be stored in compact areas, such as in a compartment on a gun. The cleaning patch includes parallel and perpendicular lines of perforations, such that patches of desired size and shape can be torn off in any two-dimensional size desired. It is contemplated that the cleaning system applies to more than just cleaning materials for firearms.

This application claims benefit under 35 U.S.C. §119(e) of provisional application Ser. No. 60/776,612, filed Feb. 24, 2006, entitled FIREARM CLEANER POUCH, PATCH, AND METHOD OF USE, the entire contents of which are incorporated herein in their entirety.

### BACKGROUND

The present invention relates to a kit for cleaning firearms, and includes aspects relating to a configured pouch and configured patch, and to a method of use related to the same. However, several aspects of the present invention are not limited to only cleaning firearms and firearm components, but instead are believed relevant to any two-step cleaning product and process, and also to providing manually-separable patches that can be broken down into desired sizes at the point of use, as explained below.

The gun and gun care products industry is a highly competitive one, requiring strong and continuous efforts to minimize the cost of materials, and to minimize assembly and packaging costs, while optimizing ease and efficiency of use. Further, some products may be used in the field, such as while hunting. These products preferably must not be bulky, heavy, cumbersome to use, nor difficult to carry and store. Even products that are used at a base camp, such as gun cleaning products, should preferably be easy to use and store. In particular, it is desirable to have a single product that meets multiple needs, that can be used multiple times, and that is flexible enough to be used on different guns so that the total number of products carried to the base camp can be minimized.

One particular group of products of concern are cleaners and cleaning paraphernalia used to clean guns and firearms. Historically, a patch is wet and is pushed/pulled through a gun barrel to clean the barrel, as well as using the patch to wipe clean other components that become dirty and dusty from debris collected in the field and when firing the gun, such as the breech. It is preferable to provide a patch that is adapted for use in differently-sized barrels, but that does not have to be cut with a separate cutter in order to shape it prior to use. Further, it is desirable to provide a patch that does not need to be doused with cleaning fluid . . . and in particular, it is desirable to not have to mess with a bottle of cleaning fluid. This is particularly true when using the cleaning product in the field or in a closed environment.

In military applications, the above problems are greatly emphasized and further additional problems are presented. For example, soldiers often simply cannot carry more stuff.

Therefore, whatever the product is, it can't be heavy, bulky, cumbersome to use, nor difficult to carry and store. Soldiers often work under stressful conditions and when they are tired, which aggravates any problems noted above. Further, they often must clean their guns in dirty and undesirable environments. In some applications, such as with special armed forces, their life will literally depend on a clean fully-functioning firearm. They literally do not have the time (nor the desire) to mess with detailed procedures or instructions.

Thus, a system having the aforementioned advantages and solving the aforementioned problems is desired . . . including ease of use, storability, small size, adaptability and flexibility of use.

### SUMMARY OF THE PRESENT INVENTION

In one aspect of the present invention, an apparatus for cleaning firearm components includes first and second compartments with first and second access openings to the first and second compartments, respectively. A wet gun cleaner material is located in the first compartment and a dry wipe sheet material is located in the second compartment. By this arrangement, a two-part cleaning system is provided where the wet and dry cleaners are readily available and retrievable from storage.

In another aspect of the present invention, a method for cleaning components includes providing a resealable first compartment with wet cleaner material therein, and providing a resealable second compartment with dry sheets therein. The method includes closing and then folding the first and second compartments to a sealed compact portable shape, and further includes storing the folded first and second compartments until use.

In another aspect of the present invention, an apparatus for storing items includes a thin flexible pouch made of top and bottom flexible sheets of material secured together along opposing sides and further bonded along a line extending generally perpendicularly between the opposing sides to define two adjacent compartments. The sheets define separate access openings to the two compartments and include re-attachable seals for resealing the access openings. The sheets are flexible and also resistant to evaporation of materials such that volatile materials can be stored therein, yet the pouch can be folded and stored in compact areas. First and second cleaning patches are placed in the first and second compartments, respectively. The cleaning patches have different amounts or types of products thereon for cleaning an article, such that a most appropriate one of the first and second cleaning patches can be selected for use to clean a particular article.

In still another aspect of the present invention, an article for cleaning a firearm includes a sheet suitable for cleaning a barrel and other components of a firearm. The sheet includes at least one line of perforations permitting a user to manually tear off a patch of desired size from the sheet without the need for a separate cutter. In a narrower form, additional lines of perforations are provided, some parallel the first line of perforations, and others perpendicular to the first line of perforations, such that “any” size patch can be torn from a virgin sheet.

These and other aspects, objects, and features of the present invention will be understood and appreciated by those skilled in the art upon studying the following specification, claims, and appended drawings.

### BRIEF DESCRIPTION OF DRAWINGS

FIG. 1 is an exploded perspective view showing a solvent-wetted melt-blown perforated sheet ready to be inserted into a first compartment of a pouch and showing a dry melt-blown perforated sheet already positioned in a sealed second compartment of the pouch.

FIGS. 2-3 are top and perspective views of the melt-blown sheet from FIG. 1, FIG. 2 showing a patch being partially torn from a base melt-blown perforated sheet including showing perforation lines, and FIG. 3 showing a perspective view of a top surface of the melt-blown perforated sheet.

FIG. 4 is a plan view of FIG. 3, with both wet and dry sheets positioned in respective sealed compartments.

FIG. 5 is a cross section of FIG. 4.

FIG. 6 is a cross-sectional view of a modified pouch similar to FIG. 5.

FIG. 7 is a flow chart showing a method of use.

### DETAILED DESCRIPTION OF PREFERRED EMBODIMENTS

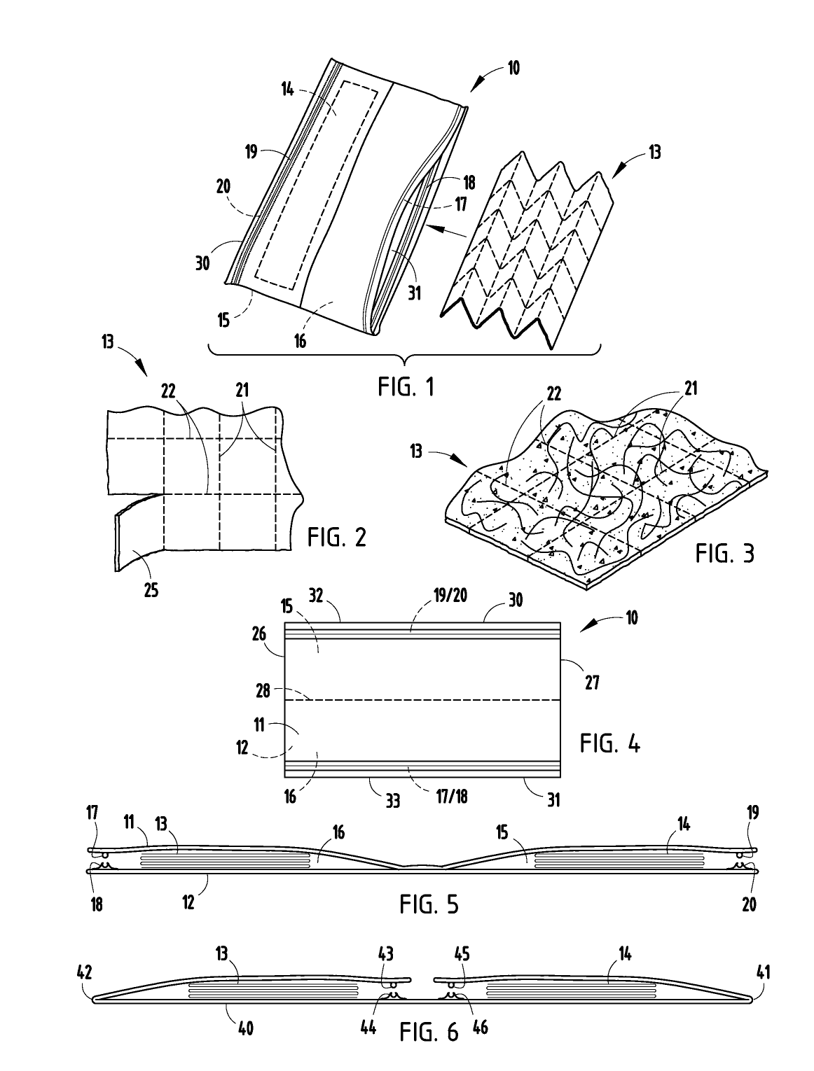

A cleaning system (FIG. 1) includes a foldable pouch 10 made of two polymeric sheets 11, 12 thermally bonded to form two compartments 15, 16, one with wet melt-blown sheet 13 and another with dry melt-blown sheet 14, each adapted for cleaning gun barrels and firearm components. The compartments 15, 16 are closed with zip-lock members 17-18 and 19-20 offering easy access and resealability. The pouch 10 is foldable and takes up minimal space and is lightweight, such that it is able to be stored in compact areas, such as in a compartment on the gun itself. The cleaning patch (i.e., melt-blown sheet 13) includes parallel and perpendicular lines of perforations 21, 22, such that patches of desired size and shape can be torn off in any size two-dimensional shape desired, thus satisfying personal preference and specific needs. It is contemplated that the present inventive cleaning system applies to more than just cleaning materials for firearms. For example, the present pouch can be used to form a kit carrying materials for a process requiring two sequential steps using different materials. An example would be a kit including both wet and dry materials for wet and dry sanding . . . or including two different grit abrasive sanding papers. The present pouch can also be used for processes where a best material needs to be selected on-site at a work location. An example would be a pouch including patches coated with two different strength solvents, such as for cleaning a soiled carpet . . . or pre-spotting clothing prior to washing.

Patch

It is contemplated that the patch 25 can made from any sheet material that adequately absorbs and is able to carry the cleaning solution. Such sheets are widely known in the art. For example, melt-blown polypropylene (PP) (FIGS. 2-3) is known to work well for the purpose of cleaning gun barrels and firearm components. Such sheet material is made by melting resin through a die and laying continuous fine filaments down on a moving conveyor to create a web (often called the “spun melt process” in the art). Most (i.e., about 75%) of the world's spun melt materials are made with PP. A general description of materials that could be used as a substitute are materials that absorb or hold oil or solvent based solutions. The present melt-blown polypropylene sheet is commonly used in oil cleanup situations because it attracts oil. Cloth is also sometimes used, and the present concepts are believed to encompass using such additional materials.

Parallel and perpendicular lines of perforations 21, 22 are made into the illustrated sheet material 13 with sufficient density and size, such that sections of the raw sheet can be manually torn off to create patches of a desired size and shape. The particular size and shape will depend on the cleaning task at hand, and also will depend on user preference. It is contemplated that the perforations can be in squares or different size circles, or even different size ovals. It is contemplated that the spacing of the perforation lines can be as low as ½ inch or less, or can be larger in size. It is also contemplated that the present system can be used with non-toxic gun cleaner solutions, as well as with toxic gun cleaner solutions now in use in the military.

Pouch

The illustrated pouch 10 (FIGS. 4-5) is made from polypropylene, polyethylene, or other polymeric sheet sufficiently resistant to gun cleaner/solvent and sufficiently durable for its particular environment of use. Preferably, the material of the pouch is flexible, thin, foldable, bendable, thermally bondable, and resists evaporation of solvent or water through (into or out of) the sheet. In the case of use in a gun cleaner application, it resists evaporation of a cleaner/oil solution. It is contemplated that the material of the pouch could be a combination of different materials, such as plastic and foil, or foil only (e.g. metalized film), or plastic and paper.

The illustrated pouch 10 includes two polymeric sheets 11, 12 placed on each other, with opposing edges 26, 27 thermally bonded together and sealed. There is also a perpendicular line 28 of thermally bonded material extending perpendicularly between the opposing edges to form the first and second compartments. The illustrated sheets are bonded by thermal bonding, however it is contemplated that they can be sealed by RF welding, sonic welding, adhesion, or by other methods known for bonding plastic materials.

The compartments 15, 16 include access openings 30, 31 formed near opposite edges 32, 33. A resealable closure is provided at each access opening, such as a zip-lock closure 17-18 and 19-20. It is contemplated that the closure may also include a reusable adhesive, a folded over hook-and-loop (Velcro) attachment, or other attachment that provides a solution-tight seal.

The present pouch 10 is much like a flexible foldable bi-fold wallet. Also, the pouch is bendable, and can withstand multiple folding or “crumpling,” which allows it to fit into tight and compact storage areas. Hence, the illustrated pouch can be easily stored in relatively flat and small spaces, such as in a compartment in a gun stock or other confined space.

The present pouch 10 with patches/sheets 13, 14 therein (wet and dry), is extremely lightweight and easy to carry. It is not bulky, and provides extremely easy access. Further, it is extremely flexible in use, adaptable, and reusable. The illustrated sheets 13 and 14 are folded in an accordion style in order to fit into the compartments. It is contemplated that other folding arrangement can be used, and/or that multiple separate sheets can be placed in each compartment. It is also contemplated that the amount of solution and composition of the solution wetting the “wet sheets” can be varied for the particular application of use intended. The present sheets 13 and 14 are reusable, but it is also contemplated that disposable sheets can be used.

It is contemplated that the pouch can be modified to have differently positioned and oriented compartments and access openings. For example, FIG. 6 shows one variation pouch 39 where a single sheet 40 is folded over at edges 41 and 42 and zip-lock members 43/44 and 45/46 are provided adjacent a center area. It is also contemplated that any re-sealable zipper or zip lock structure can be incorporated into the modified pouch. Also, the re-sealable zipper could be on the outside edge, the inside edge, in a center area of the wet and dry compartments, or on the ends or top of the compartments. It is specifically contemplated that a scope of the present invention is sufficiently broad to include a method of use where the two compartments are separate pouches, and are not both part of a single pouch. It is also contemplated that the pouch could be made with perforations between the wet and dry compartments. This would allow the wet pouches and dry pouches to be carried in different locations. Also, it would allow a user to selectively decide to carry an increased number of wet sheets . . . or an increased number of dry sheets. For example, the military might decide for some operations that they need to double the number of wet pouches as dry pouches, so they separate the pouches to carry twice the number of wet pouches.

Gun Cleaning Kit

The present cleaning kit works with any two-step process or two-type cleaner method or any method where a choice of materials at the job site is desirable. For example, the kit allows the user to carry the kit (pouch) with them, and to choose the best of two cleaners at the point of use. Also, the kit allows the user to use a first “rough cut” or strong solvent (or in the case of gun care, a wet cleaner), and then use a “light cut” or weaker solvent (or in the case of gun care, a dry wipe). The kit can be folded and stored basically anywhere, is resealable, is easily accessible, and is amazingly lightweight and non-bulky, making it easy to carry and to use.

Use

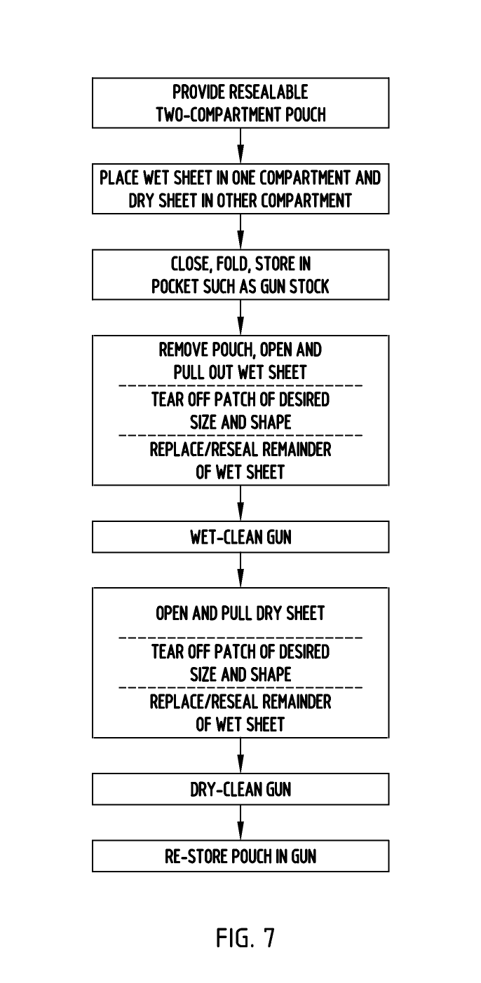

To use the present kit (FIG. 7), the wet compartment 15 is unzipped, and a desired size of patch 25 is torn off along a perforation line. This is accomplished without the need for a separate cutting tool, such as a knife or scissors. The remaining wet sheet is then replaced into the “wet” compartment 16, and the “wet” compartment is resealed to keep its contents wet and clean. After using the wet patch, it can be discarded or put back into the wet compartment. The dry compartment is then unzipped, and a desired size of patch (25) is torn off along a perforation line. Again this is accomplished quickly and easily and without the need for a separate cutting tool. The remaining dry sheet is then replaced into the “dry” compartment, and the “dry” compartment is resealed to keep its contents dry and clean. After using the dry patch, it can be discarded or put back into the dry compartment. The pouch is then folded in two (or folded in multiple lines) and placed in a desired compact storage area.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. An apparatus for cleaning firearm components, comprising:
first and second compartments with first and second access openings, respectively;
wet gun cleaner material located in the first compartment; and
dry wipe sheet material located in the second compartment.

2. The apparatus defined in claim 1, including a single pouch defining the first and second compartments.

3. The apparatus defined in claim 2, wherein the access openings face in opposite directions.

4. The apparatus defined in claim 3, wherein the pouch comprises a flat, foldable, two-layer article.

5. The apparatus defined in claim 4, wherein the access openings each include a resealable closure.

6. The apparatus defined in claim 5, wherein the resealable closures include a zip lock structure.

7. The apparatus defined in claim 6, wherein the pouch is made of thin plastic sheets that prevent evaporation of a solvent.

8. The apparatus defined in claim 1, wherein the pouch is made from two sheets sealed along opposing edges and along a centerline therebetween.

9. The apparatus defined in claim 8, wherein the pouch is foldable and adapted to fit into a compartment in gun.

10. The apparatus defined in claim 9, wherein the pouch is thermally sealed along opposing edges.

11. A method for cleaning components, comprising:
providing a resealable first compartment with wet cleaner material therein; and
providing a resealable second compartment with dry sheets therein,
closing and then folding the first and second compartments to a sealed compact portable shape; and
storing the folded first and second compartments until use.

12. An apparatus for storing items, comprising:
a thin flexible pouch made of top and bottom flexible sheets of material secured together along opposing sides and further bonded along a line extending generally perpendicularly between the opposing sides to define two adjacent compartments in a bi-folding arrangement; the sheets defining separate access openings to the two compartments and including reattachable seals for resealing the access openings; the sheets being flexible along bonded areas and flexible along the seals and also being resistant to evaporation of solvent materials such that solvent materials can be stored therein, yet the pouch can be folded and stored in compact areas; and
first and second cleaning patches placed in the first and second compartments, respectively, the cleaning patches having different amounts or types of products thereon for cleaning an article, such that a most appropriate one of the first and second cleaning patches can be selected for use to clean a particular article.

13. An article for cleaning a firearm, comprising:
a sheet suitable for cleaning a barrel and other components of a firearm; the sheet including at least one line of perforations permitting a user to manually tear off a patch of desired size from the sheet without the need for a separate cutter.

14. The article defined in claim 13, wherein the sheet includes a fibrous sheet of melt-blown polypropylene material coated with a solvent material to assist in cleaning the barrel.

15. The article defined in claim 13, wherein the sheet includes at least one additional line of perforations oriented perpendicularly to the first-mentioned line of perforations to facilitate manual tearing of the sheet in a second direction to remove the patch of selected size in two dimensions.

16. The article defined in claim 13, wherein the sheet includes random fibers forming a rough structural surface shaped to assist in cleaning the barrel and other metal components.

17. The article defined in claim 13, wherein the sheet comprises a fibrous sheet with pockets and depressions therein for holding debris collected while cleaning the firearm.

18. The article defined in claim 13, wherein the at least one line of perforations includes a plurality of parallel lines of perforations, each being at least about 1 inch apart.

19. A gun cleaning kit comprising:
a foldable pouch with a wet compartment containing a plurality of wet patches adapted to clean a gun barrel and a separate dry compartment containing a plurality of dry patches for drying the gun barrel.

20. A storage pouch comprising:
top and bottom flexible foldable sheets made of material resistant to evaporation therethrough of solvents, the sheets being bonded together to form two separate pockets bound on three sides with bendable bond lines and defining separate access openings on a fourth side and having a resealable zip lock closure structure on each of the access openings for selectively closing the two separate pockets.
